(19) United States
(12) Patent Application Publication
(10) Pub. No.: US 2005/0105769 A1
(43) Pub. Date: May 19, 2005

(54) Toy having image comprehension

(76) Inventors: Alan D. Sloan, Atlanta, GA (US); Ruifeng Xie, Roswell, GA (US)

Correspondence Address: ARNALL GOLDEN GREGORY LLP, 1201 West Peachtree Street, Atlanta, GA, 30309, US

(21) Appl. No.: 10/718,853

(22) Filed: Nov. 19, 2003

(51) Int. Cl. G06K 9/00; G06K 9/62; G05B 15/00

(52) U.S. Cl. 382/103; 382/209; 700/259

(57) ABSTRACT

An interactive device, such as a toy, equipped with an image similarity engine capable of receiving external visual inputs and providing corresponding physical outputs. The device captures an image, compares the captured image with images stored in a database, and provides physical outputs according to the recognized images.

### BACKGROUND OF THE INVENTION

1. Field of the Invention

The present invention generally relates to computer systems for image processing. More particularly, the present invention relates to apparatuses and methods that produce a physical output according to an external visual input.

2. Description of the Related Art

At the current state of technology, real world images are captured in an analog media and typically digitized before being processed by computers. Other images are digitally created in the first instance. Such digital images often are, initially, simply arrays of intensity and color information, but may be stored or processed in a specific format, such as JPEG, MPEG, or wavelets for efficiency or other reasons. Normally sighted humans of normal intelligence have the ability to look at real world images, hardcopy images, and projected images and determine their relevance in a variety of circumstances. However, once images are in a digital format, humans lose much, and in many cases, all, ability to look at the digital image data and determine relevance.

Image Understanding (“IU”) is comprised of methods, implementations and applications that let computers to process digital image data for the purpose of simulating the interaction of humans with a visual environment. IU may be constrained (Constrained IU) if it is for a specific class of images. An example of a Constrained IU is an Optical Character (“OCR”) Recognition Processor (“OCRP”). An OCRP is capable of converting the digital data resulting from an optical scan of a page of text into characters that a computer can identify. An OCRP needs to be able to determine what data represents text information and what data represents noise introduced by the scanning process such as coffee spills on the original document.

The digital acquisition of characters is the starting point for an OCRP IU processor, which would need the ability to produce a wide variety of output according to the input. Some output is easily produced. For example, a computer can count the number of characters in the page of scanned text as well as a human can count the number of characters in the original. Other output is problematic. For example, semantic interpretation can be difficult: the meaning or importance of a sentence or phrase may depend not only on nearby words, phrases and sentences, but on other associated pages. The meaning or importance of a page of text may depend not only on the aggregate and relationship of its words, paragraphs and sentences, but on related text pages. The relationship between OCR and Text Document Constrained Image Understanding gives the flavor of the relationship of Image Recognition and Image Understanding in general.

Aerial photography is another example of an image class where Image Understanding can be used. Image analysts in this field may need to determine when a change in two images is relevant. For example, there may be many changes in a image of a military site due to seasonal changes, weather conditions or illumination conditions, whereas other changes may be due to a camouflage of a construction site. Embedding the analyst's expertise in a computer would yield an Aerial Photograph Constrained Image Understanding Processor.

Another example of Image Understanding is film development for photographs. Often people in pictures appear to have red eyes, due to reflection of the flash. Red eye reduction is the process of finding in pictures people with red eyes and altering the pictures, so that any red eyes are replaced by normal-looking eyes. Red eye reduction is currently very much a manual process. However, a Face Constrained Image Understanding processor can do this automatically.

An ideal Unconstrained Image Understanding Processor would be able to processes arbitrary images and provide the information relevant to any specified use. Current implementations of Image Understanding Processors are constrained to specific types of image such as text example given above. If a scanned picture of a banana were to be input to a text processor, little or no useful information would result. The basic implementation method of a Constrained Image Understanding Processor is to embed structural information about the image class into the processor, then measure the structural components in an image of that class and draw meaningful conclusions based on that measurement. An Unconstrained Image Understanding Processor removes the constraint of image class.

Presently, toys have a very limited ability to interact intelligently with the user. Many toys have mechanical buttons, including wheels, sticks, electronic buttons, or remote control devices, which, when properly moved, cause the toy to respond with motion, sounds, video displays, or lights. Some toys contain speech or music generators and can respond with speech or music. Other toys contain sound or light recognition processors that cause the toys to respond to speech, sound, or light. Still other toys contain image recognition processors which cause the toys to respond to specific patterns, such as, for example, a miniature car that follows a black line on a white background. Such toys lack the ability to interact with arbitrary factors in the environment, cause the user to tire of the predictable and limited range of behavior, and provide limited educational value.

### SUMMARY OF THE INVENTION

For reasons described above, it is desirable to provide a system and method to enable a toy to interact more intelligently with its environment, in which the toy is not constrained to interact with only pre-defined images and image classes. Intelligent interaction with a visual environment is also valuable in other applications such as security, education and consumer products, which can be standalone applications or be embedded in, or otherwise interact with, a toy or other intelligent image interactive products.

In one aspect, the invention is a toy that receives inputs from an environment and provides a corresponding response either generally or user-specific. The toy includes an image sensor for capturing an external image of an object, an image similarity engine for comparing the external image to a plurality of stored images, and an event processing engine. The image similarity engine calculates a similarity score based on the comparison of the external image to a stored image, and the event processing engine creates a new event based on such similarity scores. For example, when one similarity score is greater than or equal to a pre-defined threshold score, and the event processing engine executes one or more event actions associated with a new event.

In another aspect, the invention is a method for interacting with a toy, wherein the toy receives inputs from the environment and provides an output according to the inputs received. The method includes sensing an external image, calculating a similarity score based on a comparison between the external image with at least one stored image, if the similarity score is equal to or bigger than a predefined threshold score, generating a new event object, and executing an event action associated with the new event object.

Other objects, advantages, and features of the present invention will become apparent after review of the hereinafter set forth Brief Description of the Drawings, Detailed Description of the Invention, and the Claims.

### DESCRIPTION OF THE DRAWINGS

FIG. 1A depicts a toy according to the invention.

FIG. 1B depicts an architecture of the invention.

FIG. 2 depicts an alternate architecture of the invention.

FIG. 3 depicts an event entry.

FIG. 4 depicts internal components of an image understanding engine.

FIG. 5 illustrates internal components of a database managing engine interfacing with the database.

FIG. 6 depicts different types of data and their interaction.

FIG. 7 illustrates a flow chart for a toy according to the invention.

### DETAIL DESCRIPTON OF THE INVENTION

In this description, the terms “event action” and “reaction chain” are used interchangeably, and like numerals refer to like elements throughout the several views. According to the invention, an Image Similarity Engine (ISE) is a means for determining how similar one image is to another image. Given two images, A and B, an ISE will produce a numerical indicator Similarity Score S(A,B). The Similarity Score S(A,B) indicates how similar A is to B, and it is not necessary that S(A,B)=S(B,A).

An ISE can be normalized so that S(A,B) is always between 0 and 1 and S(A,A)=1 for all A's. An ISE may have adjustable parameters that affect the production of S(A,B). For example, it may be desirable to have S(A,B)=1 whenever A is produced by rotating B 180 degrees. In other cases, it may be desirable to distinguish between such rotated images, and the choice can be indicated by a parameter. In other cases it may be desirable to reduce costs or computation latency by determining S(A,B) faster, but at the cost of a somewhat less realistic estimate of the similarity of A and B. Again, such a choice may be affected by a parameter choice.

Some ISEs are constrained, for proper functioning, to image classes specified by an underlying image structure. For example, a face-constrained ISE might function by identifying features specific to human faces, measuring details related to those features, and then determining similarity of two faces by comparing corresponding measurements. For example, a face image class may require the presence of some or all of specific face features (e.g. nose, eyes, mouth) in the image and the determination of measures of the location of those features (e.g., the distance between eyes and the distance between eyes divided by the distance from the mouth to the nose). Expertise in the field of face images is required to know which measures are useful and how carefully they must be measured. While it may be technically possible to input images of a car and a fire hydrant into such an Engine to cause it to compute a similarity of a car and a fire hydrant, such a similarity measure will tend not to have any significance because neither the car nor the fire hydrant has the structural features assumed in the definition of the class of face images. In contrast to the ISE, an Unconstrained Image Similarity Engine (UISE) is an ISE that is not constrained to specific image classes for proper functioning.

An Image Understanding Engine (IUE) contains an ISE. An Unconstrained Image Understanding Engine (UIUE) is an IUE whose ISE is Unconstrained. A fractal based UIUE is an IUE whose ISE was described in a co-pending patent application (U.S. patent application Ser. No. 10/274,187), which is incorporated herein in its entirety by this reference. One method disclosed therein for computing S(A,B) is to select a plurality of subsets of A, called domain regions, to select a plurality of other regions from A, called range regions of A, to select a plurality of other regions from B, called range regions of B, to select a collection of transformations which transform some or all range regions, and a metric d which provides a measure, d(D,T(R)),of the difference between a domain region D and a transformed range region, T(R),which is obtained by applying the transformation T to the range region R. Once these selections have been made, S(A,B) is initialized to 0. Then for each domain region, S(A,B) is incremented only when the choice of range region R, which minimizes d(D,T(R)) over all possible transformations T and range regions R, is a subset of B. One aspect of the invention disclosed in that application was a method for choosing a value for the increment.

There are other ISE's besides those disclosed in the co-pending patent application. For example, S(A,B) may be defined by selecting a plurality of subsets of A, called domain regions, selecting a plurality of regions from B, called range regions of B, and selecting a local error, d. The local error d provides a measure, d(D,R) of the difference between a domain region D and a range region R. For each domain block D of A, choose a subset of SUB(D) of all range regions of B. For example, the domain and range regions are squares having sides of length z pixels, and if (x,y) are the coordinates of the upper left hand corner of D, and if w is a positive integer, then SUB(D) may be defined as the set of all range blocks R having upper right hand corners (x′,y′) satisfying the condition: (x-x′)²+(y-y′)²<w², and the local error d may be defined as the square root of the sum of the squares of the differences of the corresponding pixel values in D and R. The choices of range blocks, domain blocks, local error and SUB are restricted, so that for each domain block D there is a range block R(D) in SUB(D) that minimizes d(D,R) for R in SUB(D). Finally, define S(A,B) as a function of the d(D,R(D))'s and the choices made in computing the d(D,R(D))'s. For example, S(A,B) may be defined as the (square root(sum{d(D,R(D): domain blocks D}))/(number of domain blocks). When the size of the images A and B is small, such similarity scores may be defined so as to have advantages over the fractal Similarity Scores disclosed in the previous patent application.

There are at least two image inputs to an IUE, one of which is a source of external digital images reflecting an environment. Examples of such an external source of digital images include a live video camera, a remote video camera connected to the IUE by means of the Internet, or a DVD player. It is understood that such external video source may be pre-processed in the IUE, or external to it, to reduce noise, equalize histograms, scale to a conventional size, or other purposes. Besides improving the performance, pre-processing can also help select one or more objects of interest.

A second image input to an IUE comes from an Image & Meta (I & M) database. The Image & Meta database consists of stored images and related data that may be suitable for identification, characterization, categorization, classification and other use of the image. Different images may be associated with quantities of and types of data. For example, one image in the database may contain the face of a child, named John, taken in the kitchen of his family's house. In addition to this image, the database may contain the name John, the fact that this image was taken in the kitchen of his family's house, and John's birthday. The database may classify this picture as a picture of a child taken indoors and/or classify it as a picture of a person taken in the family's house. The Image & Meta database also contains Event Data relating to the absolute or relative importance of occurrences of inputs alone or in combination.

When there are more than two image inputs to the IUE, the IUE has a means of selecting two images to serve as inputs to the ISE. The output of the ISE is an input to an Event Processing Engine (EPE). The EPE may have other inputs such as a timer, mechanical buttons, rangefinder and the output of a Voice Recognition Engine. Output from the EPE can drive external responses such as an audio speaker, an LCD screen, mechanical controls, and lights. The EPE may also control which images, in what numbers and order, are passed from the external video source and/or from the Image & Meta database to the input of the IUE. The EPE may also determine the frequency and method of sampling. The EPE may modify internal thresholds and other parameters it uses to function. The EPE may also determine when images and related data in the Image & Meta database should be modified and when images should be added to, or deleted from, the Image & Meta database.

The Event Processing Engine determines when the current input from the external video source is of some importance. For example, the EPE may select a subset of the images in the I & M database to use as the input to the ISE. The EPE may monitor the output from the ISE to see if the Similarity Score of the current external input image and one of the I & M database images exceeds a First Similarity Threshold. If the Similarity Score exceeds the First Similarity Threshold for all current external input images for a time period of at least First Time Threshold seconds, then the EPE may determine that the event “Object Recognized” occurred. Having determined that the event “Object Recognized” occurred, the EPE may initiate a command causing the audio speaker to say “Hello John” if the external image generating this event was a picture of John. If this event occurred on John's birthday it may instead say “Happy birthday John”, or sing a Happy Birthday song.

The EPE may also keep track of how long a particular image has been recognized so “Object Recognized (x seconds)” becomes an event of potential importance. For example, the I & M database may contain a sampling of face images of John from frontal to profile, and the EPE may continue to determine that Object Recognized has occurred based on the high Similarity Score generated using different images of John. For example, if the event Object Recognized(15 seconds) occurs and the images used to determine this condition are all images of John, the EPE may initiate a command to generate an output, “John, are any of your friends here?”

Other examples of the events include:
Object Not Recognized—when a new object is not in the database,
Object Recognized—when a new object is in the database and recognized,
Object Changed—when a new object is recognized, but different from a previously recognized object,
Object Stay—when an object has been recognized and stayed recognized for a period of time,
Object Missed—when an object is missed for a period of time,
Category Recognized—when a new object and its category are recognized,
Category Not Recognized—when a new object's category is not recognized,
Category Changed—when a new object's category is different from the category of a previous object,
Command—when an audio input is received,
Timer—when a timer event is received.

More complex events and responses are possible. For example, if the system saw a cat (meaning an Object Recognized event occurred and the database image triggering this event was an image of a cat) immediately after the system saw a dog, the EPE might generate an output response in response to a speech synthesis engine: “did the dog scare the cat away?” If “dog” is a database category and the system sees a first dog and then five minutes later, a second dog, it may respond to the first instance “I see a dog” while to the second instance it may respond “that's another dog.”

The EPE can also keep track of environmental information. For example, if the database has pictures of John taken in the kitchen, and the toy sees John, it may say “John, are we in the kitchen?” If the answer is no, the EPE may prompt “John, where are we?” If the answer is “den”, then the external picture that generated the Event may be added to the database along with the identifying data that it is a picture of John in the den.

Event data includes not only a description of the event but related data as well, which may include data that determines, in whole or part, a response to the occurrence of the event. The event data provides a method of prioritizing events and event responses. For example, events may be given priority ranking. A higher priority ranking would indicate to the event handler that its response should be handled prior to events with a lower priority ranking.

The response to an event, such as speech synthesis, may require a time period that overlaps the response to another event. So, in addition to priority of the event, a priority of response continuation can be used. For example, one response may be associated with a ‘continue until complete’ directive while another response may be associated with ‘don't start if new event has occurred.’ In the former case, once an event has started it will be completed. In the latter case, if an event with the response “Hello John” reached the event handler but the external image of John which initiated this event changed, so that it was now a picture of Jack, then the system would not respond with “Hello John.”

Incorporating an IUE into a toy not only increases the interactivity of the toy with its environment and the educational potential of the toy, but also offers means of balancing factors such as functionality, production costs and power use requirements. For example, a computational engine, such as a general purpose CPU or a CPU embedded in a chip with other functionality such as image processing or a digital signal processing, is needed to drive the IUE. Memory is also need to store the external digital images, intermediate computational results, digital output, and Image & Meta database data.

Production costs of computational element and memory differ significantly depending on specific functionality incorporated into the toy. For example, if memory is inexpensive compared to computational element, the output of a Voice Recognition Engine may be key words. Thus, if the key word “who” is detected, then the output of the IUE to the Speech Synthesis Engine may be either “I do not know” or the name of a person whose image is stored in the I & M database. Therefore, upon noting the key word “who,” the EPE will only pass images in the category of people to the ISE, thus reducing the amount of computation the ISE needs to perform compared with using all images in the I & M Database. Thus, much inexpensive memory can be used without substantially increasing the computational requirement.

The above example demonstrates that the IUE can reduce latency, which is the time delay until the system reacts to a stimulus. Searching a relevant subset of the database will reduce latency compared to an exhaustive searching. For example, if for cost constraints a processor must be selected that can only search through 100 images of size 25×25 pixels with a latency that is deemed acceptable based on user testing and cost constraints permit a database of 10,000 images, then the EPE needs to select at most 1% of the available images for each external image it processes. As above, the EPE may make its selection with the help of data that relates, at least in part, to such external image. It may also use historical data of the frequency and pattern of event occurrences.

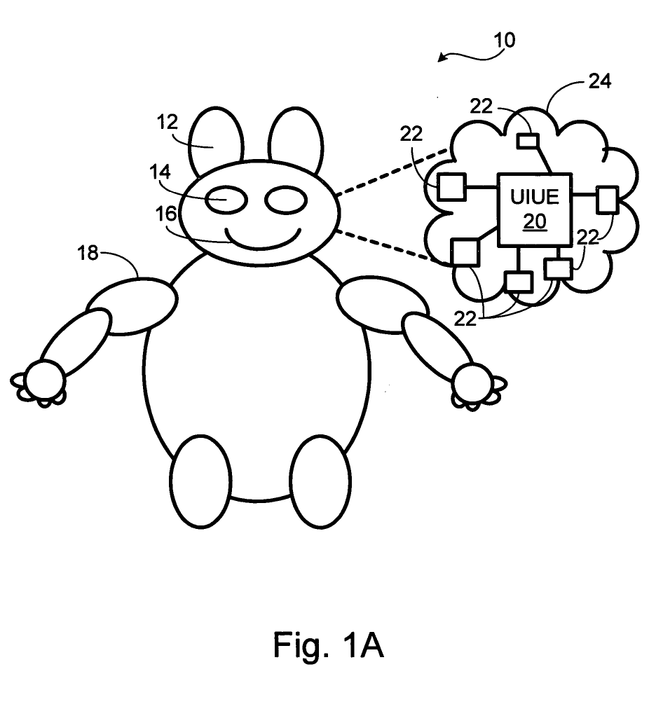

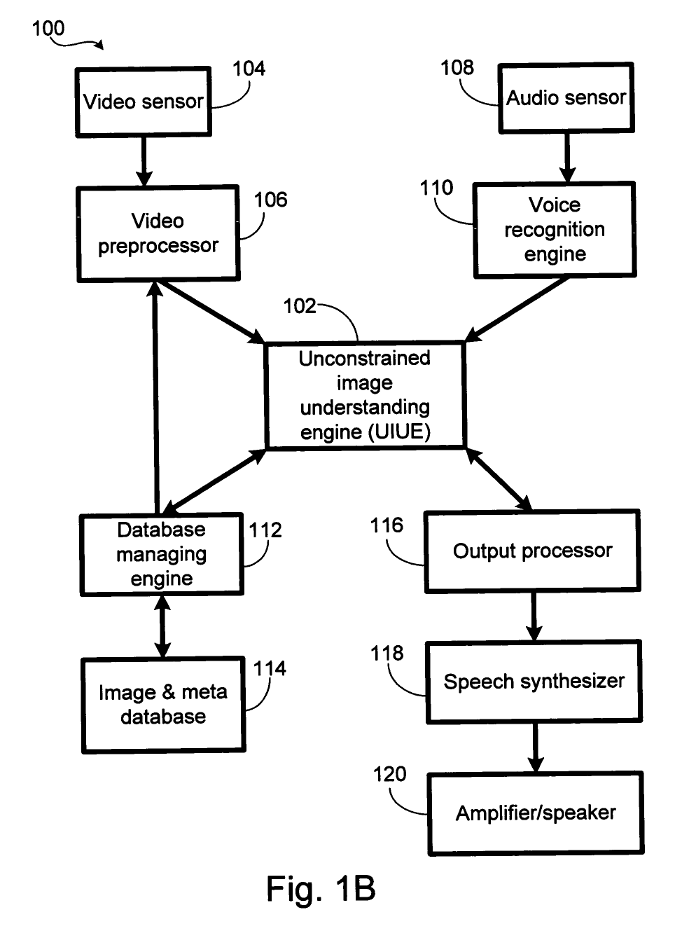

FIG. 1A depicts a toy 10 (teddy bear) according to the invention. The teddy bear has a microphone 12 built in its ear, a camera 14 embedded in one of its eyes, a speaker 16 hidden in its mouth, and mechanisms to allow it to move its limbs 18. The embedded devices provide inputs to and receive outputs from a system 24 residing in the toy. The system 24 has an unconstrained image understanding engine (UIUE) 20, which interacts with peripherals subsystems 22 that are in communication with the embedded devices. After purchasing the teddy bear 10, a parent can “train” it to recognize his child, so later the teddy bear 10 will be able to identify the child and provide more intelligent interactions with him. For example, when the child approaches the teddy bear 10, the teddy bear 10 sees the child through its camera 14, recognizes the child with help from UIUE, and greets the child with “Hello Melody” coming out from its speaker 16. The teddy bear 10 may also move its arms or light up its eyes to show affection toward the child.

FIG. 1B depicts an architecture 100 according to the invention. An interactive toy according to the invention is in essence a highly specialized computer that includes a video (image) sensor 104 and audio sensor 108. The video and audio sensors may be distinct units or a combination unit such as a QuickCam Pro 4000 video camera by Logitech. The interactive toy includes a video preprocessor 106, a voice recognition engine 110, an unconstrained image understanding engine (UIUE) 102, a database managing engine 112, an image & meta database 114, an output processor 116, a speech synthesizer 118, and an amplifier/speaker 120. The video preprocessor 106, voice recognition engine 110, Unconstrained Image Understanding Engine 102, Database Managing Engine 112, Output Processor 116, Speech Synthesizer 118, and Image & Meta Database 114 may be implemented in software or by means of special purpose components in the interactive toy. A commercially available speech synthesizer 118 is connected to a commercially available audio speaker 120 to produce audible output.

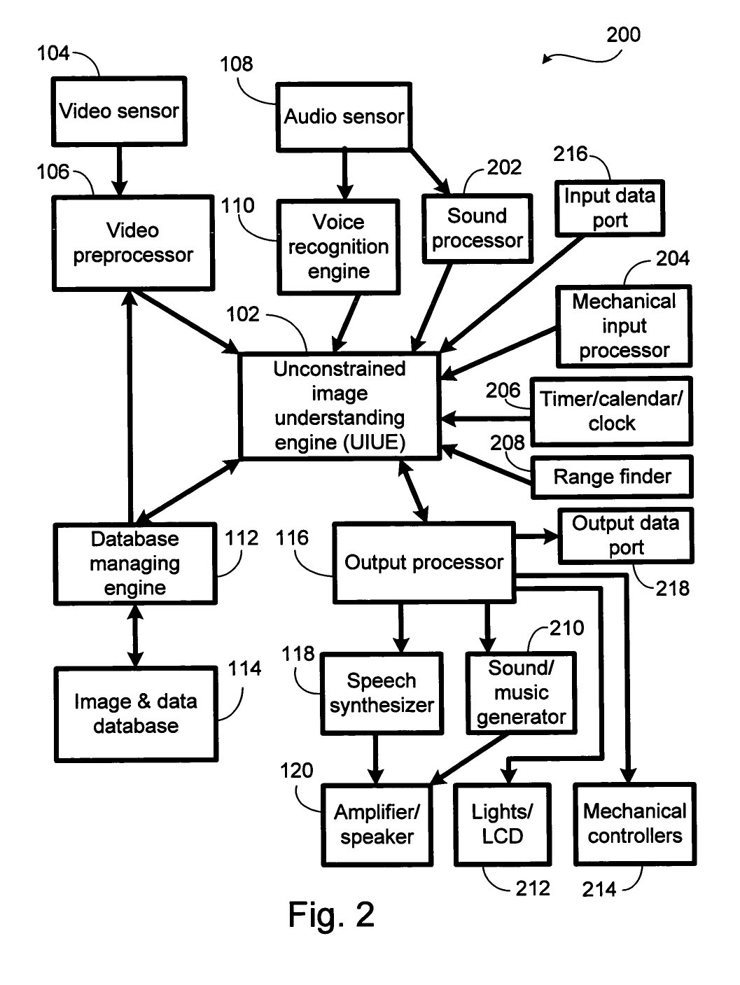

FIG. 2 is an alternative embodiment 200 of the invention. In this embodiment, the audio sensor 108 output is processed by a sound processor 202 before being processed by the UIUE 102. The UIUE 102 also receives external inputs from a mechanical input processor 204, such as a keyboard, mouse or dedicated buttons, a timer (calendar/clock) 206, and a range finder 208, and data input port 216 that receives digital data from other data sources such as a computer, the internet or other instantiations of this invention. The output processor 116 besides interfacing with the speech synthesizer 118 also interfaces with a sound/music generator 210, a lights/LDC fixture 212, mechanical controllers 214, and data output port 218 that sends digital data to other data sources such as a computer, the internet or other instantiations of this invention.

The extended implementation shown in FIG. 2 includes extra sensors and response channels. With the extra sensors, a toy may feel the touch of the child and measure the distance from the child for better interaction. A sound processor 202 processes sound events from the environment that cannot be recognized by voice recognition engine. These events provide inputs to UIUE 102 in determining environments or identifying object.

The Mechanical Input Processor 204 consists of one or several touch sensors with the capability to measure the strength of a mechanical touch. At minimum, it should be able to distinguish between lightly rubbing and hard hitting. It sends mechanical touch events to UIUE 102.

The internal clock/calendar 206 can generate calendar events based on the metadata of the objects in the database. For example, it can emit a birthday event if the current date is the birthday of one of the objects in the database. It may also emit a holiday event if the current date is holiday. Another use of the Clock/Calendar is to employ the toy as a reminder of important events. For example, the toy may remind a child to prepare gifts when mother's day is coming.

The range finder 208 can be implemented using an infra red device to measure the distance between the toy and an object. Its data may be used to adjust focus or provide hints to UIUE 102 in preprocessing video images. For example, UIUE 102 may crop and scale the images to proper size based on the distance between toy and object. The range finder 208 may also send events to UIUE 102 when an object is approaching or going away from the toy.

The lights/LCD 212 are extra channels for the toy to response to certain events. By flashing the lights grouped in some shapes, the toy may express its feeling in response to some events. It may show happy face when it recognizes a familiar object. The LCD screen 212 may be used to display the states of the toy or show some message to the child. It may also show the images captured by the toy.

The mechanical controllers 214 may consist of a controller circuit, motors and some mechanical devices. Some stepper motors may be used for precise movements. The mechanical devices 214 may drive the toy body to show some gestures as means to express itself. It may also move the mouth when the toy speaks. With the stepper motor, the toy may possess other skills such as writing and drawing.

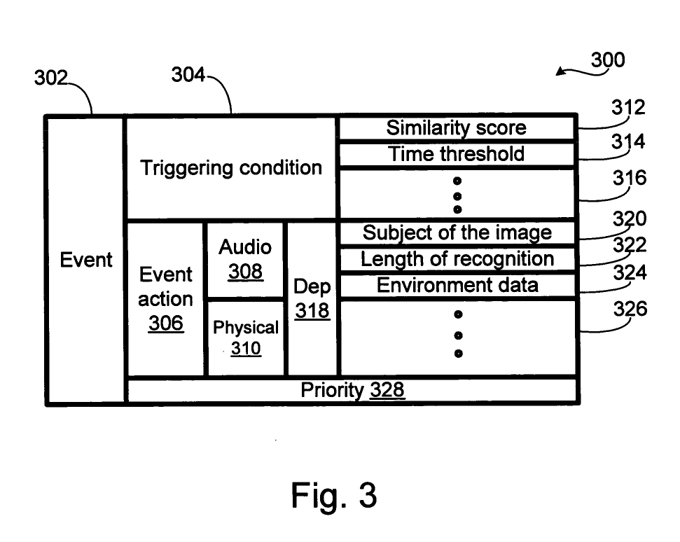

A toy according to the invention executes actions in response to external events, and an event can be an image recognized or an audio command received. FIG. 3 illustrates an event table 300. The event table 300 is associated with a set of triggering conditions 304, an event action (or a chain of actions) 306, and a priority ranking 328. The triggering conditions 304 are conditions that tell the system an event has occurred. Some triggering conditions 304 may be statistical in nature and some may be deterministic in nature. The triggering conditions 304 may include similarity score 312, time threshold 314, and other appropriate conditions 316. The event action 306 may be an audio action 308, or other physical actions 310. The event action 306 may dependent on various event factors, such as subject of the image 320, length of recognition 322, environment data 324, etc.

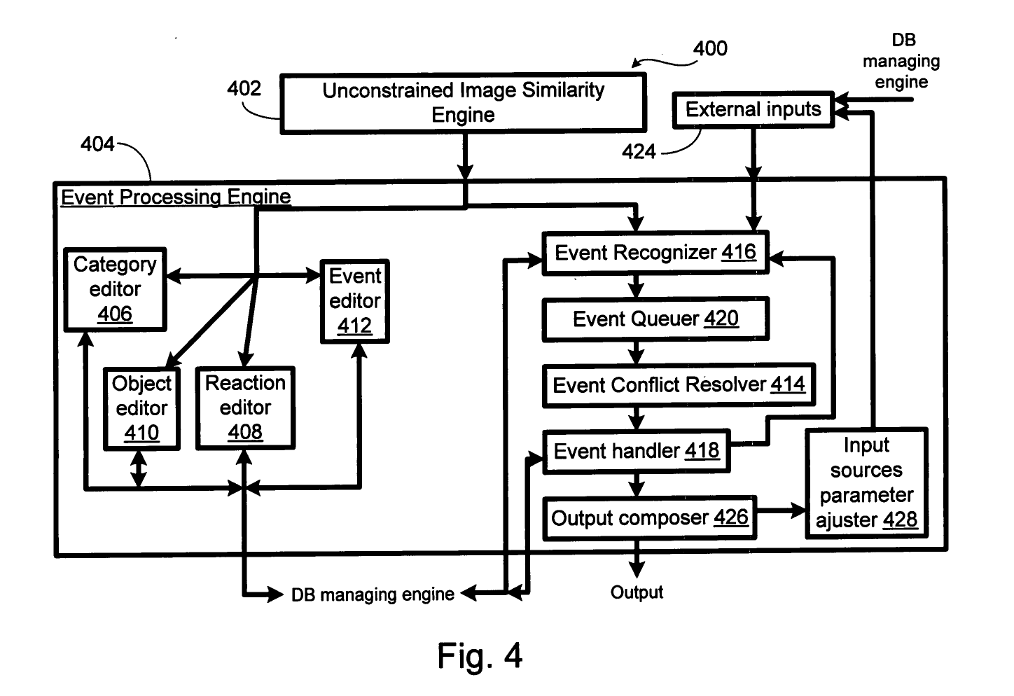

FIG. 4 illustrates an internal interface structure 400 of the UIUE 102 in a toy according to the invention. The UIUE 102 includes an unconstrained image similarity engine (UISE) 402 and an event processing engine (EPE) 404. The event processing engine 404 further includes a category editor 406, a reaction editor 408, an object editor 410, an event editor 412, an event conflict resolver 414, an event recognizer 416, an event handler 418, an event queuer 420, an output composer 426, and an input sources parameter adjuster 428. The EPE 404 also receives inputs from external input sources 424 and the database managing engine 112. The information from UISE 402 and/or the external input sources 424 may cause new events to be generated.

The UISE 402 compares one or more input images from the video sensor with one or more of the images from the database and determines which image in the searched database images is most like the input images and provides a measure of how similar the images are.

The Event Recognizer 416 collects input data from input sources, searching for the matching events object in the event database, creates event instance objects and places the created event instance object in the event queue. There are at least four types of basic events: object stay, object change, object missing and command events. Event objects are defined in the event database and are used as prototypes of instances of event objects. Event Recognizer keeps records of recognized object in the past. UIUE 102 provides the Event Recognizer 416 with the currently identified object data. With stored recognition data in the history, the Event Recognizer 416 can create event instances of types of Object Stay, Object Change and Object Missing based on the event prototypes defended in event database. Command events are created using the recognized command text from Voice Recognition Engine. If a command event doesn't contain the key data in any of the trigger events of the reaction chains, it is used as input data to the currently active waiting reactions.

The Event Queuer 420 maintains event queue, waiting queue and active queue. An event may or may not trigger responses of the toy depending on the reaction chain data in the database. If an event matches the trigger event of a reaction chain and the current state data meet the starting condition of the reaction chain, this reaction chain is put in the waiting queue.

The Event Conflict Resolver 414 resolves the conflict between the reaction chains in the waiting queue and moves the selected ones to the active queue. There may be several events generated at the same time. Hence there may be several reaction chains in the waiting queue at a time. Before moving the reaction chains from the waiting queue to the active queue, it checks the completion of the reaction chain in the active queue and removes all completed reaction chain from the active queue. A reaction chain with highest priority is then selected as the primary candidate to be moved to the active queue if current active queue is empty or the reaction chains in the active queue are not exclusive. Additional reaction chains may be moved to the active queue also if the primary reaction chain is not exclusive. Some reaction may be ignored. For example, a reaction chain triggered by an Object Missing event may be ignored if there are other more interesting reactions to be handled. This kind of events is removed from the waiting queue if there are other reaction chains in the active queue. Some reaction may be delayed. For example, a reaction triggered by a birthday event can be handled any time during the day but not necessarily at an exact time. This kind of reaction chain remains in the waiting queue if it cannot be moved to the active queue. Some reaction chains require on-time handling. For example, a reaction chain triggered by an object change event or a timer event may require an immediately handling. A delay may make the event totally obsolete. This kind of events is removed from the waiting queue if it cannot be moved to the active queue. However, it will be moved to the active queue if current reaction chains in the active queue are not exclusive.

The Event Handler 418 handles each reaction of the reaction chains in the active queue. The start time of each reaction is recorded when it is started. The Event Handler 418 checks if the previous reaction is completed or time out before start next reaction in the reaction chain. Each reaction has a time out period. When a reaction is time out, it is stopped and next reaction in the reaction chain is started. Types of reaction may include Speak, Wait For Input, Sleep, Setup Pending Object, Remove Pending Object, and Create New Object. Reactions of the type Speak are sent to the Output Composer 426 for handling. Reactions of the types Setup Pending Object, Remove Pending Object and Create New Object are redirected to the Database Managing Engine 112. Executing states are setup and maintained for the reactions of the types Wait For Input and Sleep until new input come or time out period is over.

The Output Composer 426 composes outputs using reaction's output data and current stat data. Output data may include some text with predefined token words and sound file names. The tokens in the text are replaced by the current state data. Each token corresponds some state data. For example, a token named % FromObj represents previous object when an Object Change event happens. The processed text is then sent to Text To Speech Synthesizer. Finally the synthesized speech sound data and voice data from sound file are sent to speaker.

Input sources may have parameters that control how input is collected and processed by the input device. For example, a microphone may have a volume setting, and a video sensor may have a brightness setting and image size setting. The input sources parameter adjuster 428 can adjust some such parameters based on user input and history of use. For example, there may be a large fixed amount of memory for storing images. Initially, images may be captured at 50×50 resolution as a default. If the image memory becomes full, the toy may offer the user the choice of reducing the resolution to 25×25, so that additional images may be added to the database. Alternatively, the toy may do this automatically by changing the image size setting on the video sensor input.

One of the functions of the UIUE 102 is to determine if there is a Current Object. A Current Object, if it exists, must be chosen from among Known Objects. If no Current Object exists then, by definition, the Current Object is termed to be a special pre-defined No Object, which simply means that the invention does not currently recognize an object.

Typically, when the invention is turned on, No Object will be the default Current Object. Then the UIUE 102 uses a set of rules to determine if there is a Current Object. These rules may be pre-defined and fixed, modifiable by the user explicitly, or modifiable by historical usage or environmental data. For example, suppose the video sensor is sampled 10 times per second, and V(t) represents the image, as pre-processed, which reaches the Unconstrained Image Similarity Engine at time t. Suppose also that there are 12 Known Objects, A, B, . . . , L, and 60 images in the Database, 5 images for each of the 12 Known Objects. An Image Similarity Score Detection Threshold of 57.3 is pre-selected based on experimental testing. An Image Similarity Holding Threshold of 50 is selected. A Detection Time Threshold of 0.4 seconds is selected and a Holding Time Threshold of 3 seconds is selected. These Thresholds may be pre-defined during manufacturing, set by the user, or set by the system based on the operation history. The UIUE 102 compares each of the new sensor images V(t) with each of the 60 images I representing the 12 Known Objects and computes the similarity score S(V(t),I). The UIUE 102 determines that A is the Current Object at time T if the similarity scores S(V(t), I) is highest at all times t during the 0.4 second interval preceding T when I is an image representing the object A, (as opposed to representing some other objects), and if these scores are no smaller than 57.3 during this period. Once there is a Current Object, say A, then it remains the Current Object unless some other Object, say B, becomes the Current Object, or the special No Object, becomes the Current Object. B or any other object may become the Current Object in the same manner as A. If no other Known Object, such as B, becomes the Current Object, then No Object becomes the Current Object if either (a) the highest similarity score S(V(t),I) for any of the 60 images I during times t in a period of 3 seconds is less than 50, or (b) the Known Object represented by the image I having the highest similarity score S(V(t), I) among all 60 images, is not A, during a period of 3 seconds. There are clearly many other specific criteria one can use to declare a Current Object or No Object. For example, some combination of the conditions (a) and (b) may be specified for varying amounts of time or in combination with other criteria, such as that based environmental data contained in the database.

The UIUE 102 also provides a means for entering new Known Objects. When S(V(t), I) is less than the Similarity Score Detection Threshold (SSDT) for all time t in the Detection Time Threshold (DTT) but S(V(t), V(s)) exceeds the SSDT for all times t and s in the DTT, then a new object, termed Pending Object is defined and one or more images V(t) for t in this DTT is selected to represent the Pending Object. The Pending Object is not a Known Object but has a temporary status which needs to be resolved. A Pending Object may either become a Known Object or may be discarded. The representative V(t) may be chosen so that t is the first time in the DTT interval, the last time or a mid-point, for example. Several t's may be used to select several representatives, such as the first and last t in the DTT interval. All t's in the DTT interval may be used. One method of discarding a Pending Object is to discard it if it does not become a Known Object in some pre-defined time period. One method of changing a Pending Object into a Known Object is to include as an Event the fact of a new Pending Object being created, which causes the system to query the user if he wants to name the Pending Object. If the answer is affirmative, the system then asks the user for the name and turns the Pending Object into a Known Object with the name given by the user.

The UIUE 102 operates in two modes: operation mode and training mode. In the training mode, a user may add or delete a category of objects, enter new objects, delete or modify existing objects, modify reactions (event actions), modify triggering conditions for an event, add new events, delete or modify existing events, modify event factors, etc. During the training mode, the category editor 406, object editor 410, reaction editor 408, and event editor 412 interface with the database managing engine 112.

In the operation mode, the unconstrained image similarity engine 402 compares one or more input images from the video sensor 104 with one or more of the images from the database 114, determines which image in the database is most like the input image, and provides a similarity score that indicates how similar the images are. Based on this similarity score and some preset criteria, a decision is made on whether the perceived image is the image of an object in the database 114. It then sends the results to event processing engine 404.

The event processing engine 404 collects data from input sources 424 and sends responses to output channels or executes actions based on the input data. The EPE 404 processes events in four stages:
(1) Event Composition Stage: the event recognizer 416 first collects necessary data from UISE 402, voice recognition engine 110 and other input sources. If the condition of any event object in the database 114 is satisfied by the colleted data, an instance of this event is handed to the event queuer 420, which puts it in an event queue. The event recognizer 416 keeps records of identified object and its identification time so that it can also produce object absent events after some objects are not present for a certain time. The data from Voice Recognition Engine 110 will produce command events that may trigger a series of reactions or serve the data to the Wait For Input reaction.
(2) Reaction Match Stage: the event queuer 420 checks each event in the event queue and compare its related information with the trigger conditions of the event in the database. If a matching triggering condition is found and the starting conditions of the event action 306 are satisfied by the current state data, this event action 306 is put in a waiting queue.
(3) Reaction Selection Stage: the event conflict resolver 414 checks completion of the event action, which is also known as reaction chain, in the active queue and removes all completed event actions from the active queue. The event conflict resolver 414 then finds an event action with highest priority in the waiting queue and resolves the conflicts with the rest of the event actions in active queue and waiting queue based on the handling modes (may be ignored, may be delayed and must in time), exclusive state and priorities of the event actions. The selected reaction chains (event actions) are put in the active queue. Only one of the exclusive reaction chains can be put in the active queue. The reaction chain that may be ignored or must be process in time is removed if it conflicts with the selected reaction chains. The reaction chain that must be processed in time is put in the active queue if the currently selected reaction chain is not exclusive. Multiple events can be triggered simultaneously and a second event can be triggered before the reaction of a first event is complete. Assigning a numerical priority to events and/or event actions is a way to avoid or handle conflicting events: an event or event action with higher priority is executed before those with lower priority. Since the reaction to an event can be a list of individual event reactions, it is possible that one reaction list has begun to execute but has not completed before another reaction list begins to execute. For example, a reaction to a first event may include saying hello and then waiting 10 seconds for a response. During those 10 seconds the system output is basically idle and could be used to execute a reaction from a second event. Sometimes it is advantageous not to allow a second reaction chain to begin while a first reaction chain has begun to execute and this can be accomplished by setting an “exclusivity” flag on the first reaction to indicate that no other reaction chains should begin until it is complete.

(4) Reaction Handling Stage: for each reaction chain in the active queue, the event handler 418 checks the completion of the reaction in the current executing step. If the currently executing reaction is complete, next reaction is started. The reactions include responses sent to the output channels and actions such as creating new object entry in the database or establishing waiting state to wait for inputs.

When the EPE 404 is in the training mode, the EPE 404 can access and modify information stored in the database. The training mode may be activated by an external command, such as an audio command, a physical activation, such as activating a training button, or other suitable activation means. The training mode may also be entered when an unknown object is encountered during the operation mode. The training mode may also be activated in a factory setting, when all predefined information, such as known categories and known objects are stored in a toy's memory. Once the EPE 404 is in the training mode, the following components perform various functions according to user's instructions.

Category Editor: ‘new’ command results in a text input box which provides a mechanism for the user to enter the name of a new category of images, such as ‘cat’, ‘dog’, or ‘people’. This new name then becomes a member of the list of Known Categories. A Known Category may also be assigned to have one or more ‘Parent Categories’ by means of a text input box resulting from use of the ‘new’ command in the Category Editor. For example, if ‘animals’ is a Known Category, then ‘cat’, for example, might be assigned to have the parent category ‘animal.’ Note that the entry in these, or other text entry boxes may be accomplished, for example, by voice recognition means, by means of a computer keyboard in case a computer with keyboard forms part or all of the invention means, or by downloading into an input data port if such is provided. The invention may also be manufactured with pre-existing categories, which may be modifiable by the users. An ‘edit’ command results in a text input box that provides a mechanism for the user to modify the name of the category, add, subtract or modify the associated parent categories. A ‘delete’ command, when applied to a selected category, removes that category from the list of Known Categories and removes all references to such category as parent category.

Object Editor: a Known Object is some external object which the invention can detect. A Known Object is defined by a name entered into a text input box. A Known Object may be assigned to be in one or more Known Categories. It may have other properties, such as being Active or being the Owner of the particular instantiation of the Invention. Images that are processed through Unconstrained Image Understanding Engine may associated with a Known Object and be saved in the Database along with this association.

Event Editor: an Event has a Type. Some Event Types may be pre-defined such as ‘Object Changed’, ‘Object Stays’, and ° Command’. Other Event Types may be user-defined. The Event Editor provides a mechanism for defining, modifying and deleting Known Events. The ‘New’ command in the Event Editor opens several text input boxes on a user interface screen. One of these boxes provides the mechanism for naming a new Known Event. Another of these boxes provides the mechanism for associating an Event Type with a new Known Event. Another of these boxes provides a mechanism for entering an Event Time. Another of these boxes provides a mechanism for entering an Event Key. For example, an event ‘New Known Object Detected’ maybe defined with the Event Type=Object Changed, an Event Time of 0.5 seconds and no Event Key. The UIUE determines that this event occurs when the Current Object changes into anything (except No Object) but then remains unchanged for 0.5 seconds. For another example, an event ‘Object Stays for 5 seconds’ and no Event Key. The UIUE determines that this event occurs when the Current Object remains unchanged for 5 seconds. For another example, an event ‘Yes Recognized’ with an Event Type of Command, an Event Time of 3 seconds and an Event Key=‘yes’. The UIUE determines that this event occurs when, for example, the voice recognizer determines that the word ‘yes’ has been said in the last 3 seconds.

Reaction Editor: the Reaction Editor provides a mechanism for defining, modifying and deleting Known Reactions. The ‘New’ command in the Reaction Editor opens several text input boxes. One of these boxes provides the mechanism for naming a new Known Reaction. Other box provides a mechanism for associating a Trigger Event with a Known Reaction subject to Conditions and producing a Reaction List with a Priority and Processing Mode, which will shortly be described in more detail. Suppose, for example, Cat and Dog are Known Categories and it is desirable for the invention to produce a specific response when the Current Object that is in the Category of Cat and changes to a Known Object in the Category of Dog. Then a Known Reaction, named say “Cat Changes to Dog” can be defined by first specifying the name “Cat Changes to Dog” in the naming box resulting from the ‘New’ Command in the Reaction Editor. A Trigger Event is a choice of a Known Event that is m ant to initiate the reaction further specified by the Reaction Editor and associated with a Known Reaction such as the newly defined “Cat Changes To Dog” which may be chosen as the Known Event, “Object Changes”. Known Events may be specific or general, but in any case may be further specified in the Reaction Editor by further specifying Conditions. The Conditions are comprised of a Condition List, which may be added to or removed from. A Condition consists of a statement further specifying and relevant to the Trigger Event chosen. For example, in the case of a Trigger Event=“Object Changes”, a Condition may be chosen to have the form: “(Previous\New) Object (Is\Is Not\Is In\Is Not In) X”, where one of the two choices (Previous, New) and one of the four choices (Is, Is Not, Is In, Is Not In) is selected. X is a specific Known Object if either (Is or Is Not) is selected, and X is a specific Known Category if (Is In, or Is Not In) is selected. In the example, “Cat Changes To Dog” with Trigger Event=“Object Changes”, the Condition List may consist of the two statements: “Previous Object Is In Cat” and “New Object Is In Dog”. Then, UIUE deems this event occurs only when the Current Object is in the Category of Cat and it changes to a new Current Object in the Category of Dog. The Reaction Editor may also provide a mechanism for assigning a priority to a Known Reaction. Since multiple events may occur simultaneously and additional events may occur before the completion of current Reaction, the priorities can provide a mechanism for completing or terminating a Reaction List associated with one Trigger Event when additional Trigger Events occur subsequently. In addition, a Processing Mode can be specified which determine how the Reaction is processed when conflicts occur. Examples of Processing Modes may include “Ignore on Conflict” and “Delay on Conflict”. “Ignore on Conflict” tells the system to delete this reaction if it needs to execute another reaction with a higher priority, while “Delay on Conflict” tells the system to keep this reaction for later execution at such time when no other reactions with higher priority exist.

Once the UIUE 102 deems a Trigger Event for a Known Reaction, it executes the Reactions in the associated Reaction List. These Reaction Editor provides a mechanism for defining these Reactions. In this example, a Reaction has a Type, may have Duration and/or. Output, and may have Start and/or Stop Conditions. Examples of Type may include Speak, Sleep, Wait, and Save Pending Object to Known Object. The Reaction for “Cat Changes to Dog” may have type Speak in which case Duration may not be specified and Output may be “Did the dog chase the cat away?” In this example, the speech synthesizer would output the Output as synthetically spoken words. Start and Stop Conditions may be specified as lists of the same sort as the Condition List described above and which further delay or prevent execution of the reaction or cause premature termination of the reaction. The Sleep Reaction may be used to simulate sleep, induce inactivity or provide for power regeneration for a period specified in Duration.

The Save ‘Pending Object to Known Object’ Reaction may be used to permit the invention to add to the collection of Known Objects. When the invention executes the ‘Save Pending Object to Known Object’ Reaction, the invention may also prompt for specification of a name for the new Known Object or may have a mechanism for assigning names itself. Additionally, it may add some or all of the sensor images, V(t), associated with the Pending Object to the Database and associate them with the new Known Object. It may also have a mechanism for assigning one or more Known Categories to the new Known Objection or prompt the user to specify them. The invention may also provide Reactions that result in deleting Known Objects, and adding or deleting Known Categories. It may also provide Reactions that result in adding or deleting Reactions.

The Image & Meta Database of the invention consists of images and associated data, some of which is descriptive of the images and other is descriptive of the operation of the invention and how the invention interacts with images and other data not in the database. In the implementation described here, the Image & Meta Database consists of images, each image being associated with the name of a Known Object, and some of images are associated with one or more Known Categories, Known Events, Conditions, Reactions and their associated structures. Additionally in this implementation, the Image & Meta Database contains the definitions of Known Events, Conditions and Reactions.

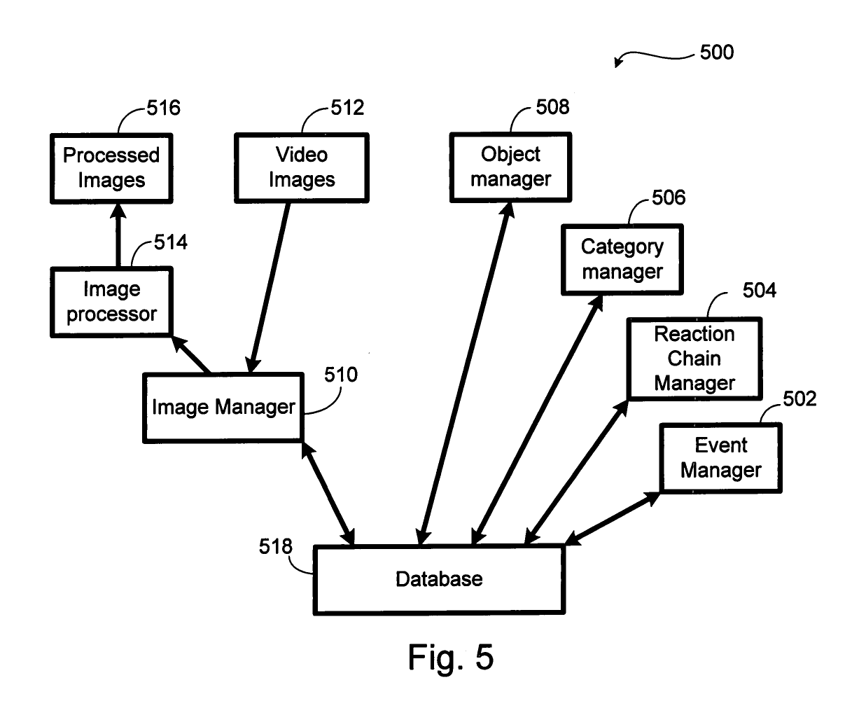

The Database Managing Engine 112 manages the creation, removal and change of all objects in the database. It provides processed images to Unconstrained Image Understanding Engine (UIUE) 102 and creates new objects in the database in response to the request from UIUE 102. It also provides preprocessed images and the information of the relationship between objects and categories. The Database Managing Engine 112 responds to the change of the environment by loading only the images it took under the same environment as current environment. FIG. 5 depicts internal components of the Database Managing Engine 112, which includes the following components: Image Processor 514, Image Manager 510, Object Manager 508, Category Manager 506, Event Manager 502 and Reaction Chain Manager 504.

The Image Processor 514 crops, scales and process images into the images with manageable size and unified characteristics. The Image Manager 510 manages image data. When it adds a new image to the database, it also creates a processed copy of the image using the image processor 514. It supplies the processed image 516 to Unconstrained Image Understanding Engine upon request.

The Object Manager 508 manages object data. The Object Manager 508 creates new object when it receives a request from the Event Handler 418. When the Object Manager 508 removes an object, it also removes all original and processed images that belong to this object through the Image Manager 510.

The Category Manager 506 manages category data. Categories have multi level hierarchical structure. The Category Manger 506 determines if an object belongs to a sub category of the category.

The Event Manager 502 manages event data. It supplies the Event Recognizer 416 with event data. An event instance is created when the data from Unconstrained Image Similarity Engine 402 or other input source matches some of the event data from the Event Manager 502. In an advanced implementation, the Event Manager 502 may dynamically modify the event data according to the accumulated data in the database.

The Reaction Chain Manager 504 manages reaction chain data. The reaction chain data is a data structure. The Reaction Chain Manager 504 maintains consistency between different parts of the reaction chain data while creating or removing a data entry.

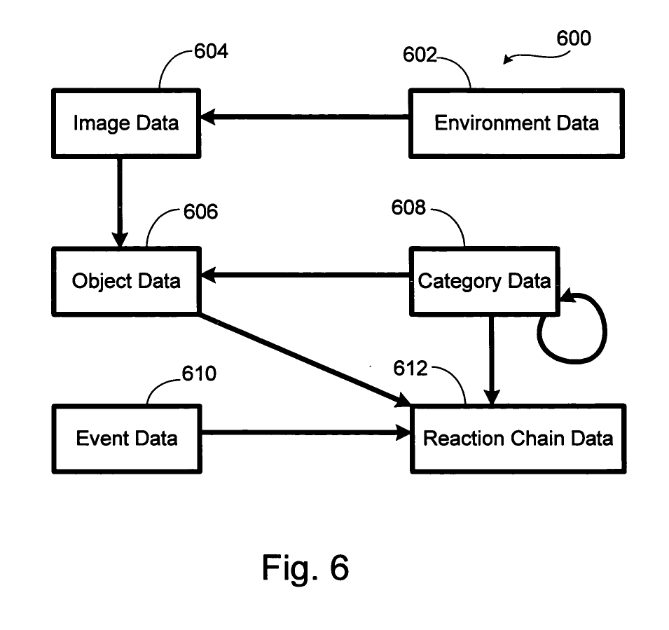

The database 114 is a relational database that consists several parts as illustrated in FIG. 6: Image Data 604, Object Data 606, Category Data 608, Environment Data 602, Event Data 610 and Reaction Chain Data 612. The Image Data 604 stores image file name, description of the image, environment foreign key and object foreign key. The environment foreign key points to the environment under which the image was taken in the Environment Data 602. The object foreign key point to the object the image belongs to in the Object Data 606.

The Object Data 606 stores object name, description of the object, category foreign key and some additional object attributes like birth date. The category foreign key points to its category in the Category Data 608. The Category Data 608 stores category name, description of the category and the key to its parent category. The Event Data 610 stores event name, description of the event, even type, event data and event time. The Environment Data 602 stores environment name, description of environment and some additional data like lighting condition. The Reaction Chain Data 612 includes trigger event, trigger condition, an array of reactions, priority, handler mode and a Boolean data indicating if the reaction chain is exclusive. The trigger event is a foreign key pointing to an event in Event Data. The trigger condition is an array of conditions with condition type and condition data. A reaction includes reaction type, output string, timeout, starting condition and ending condition. Staring condition and ending condition are arrays of conditions.

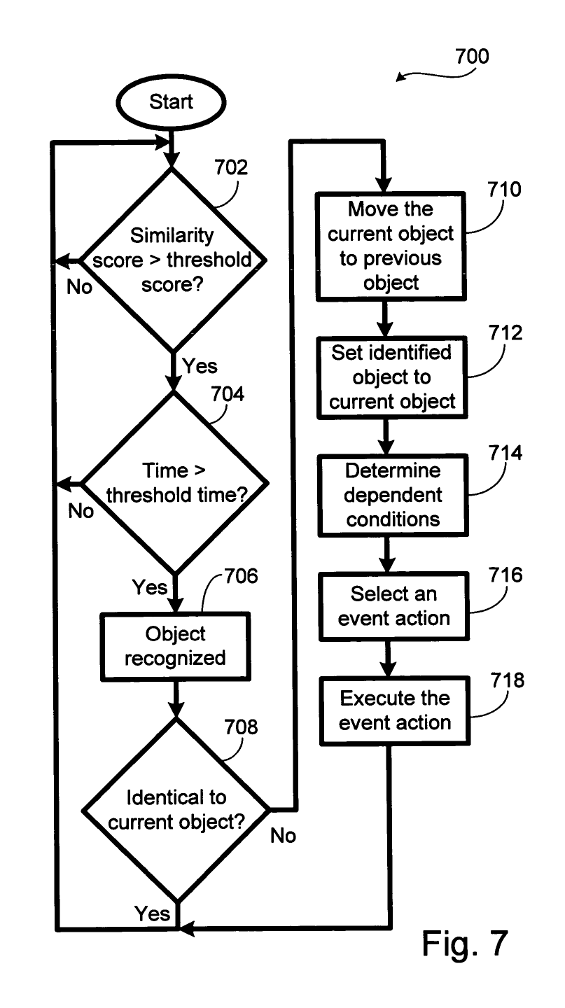

FIG. 7 is a flow chart 700 for a toy according to one embodiment of the invention. The video sensor 104 of the toy is constantly sensing images in front of it and the UISE 402 compares the image to thos images stored in the database 114. The UISE 402 calculates a similarity score for the the image. If the similarity score is bigger than a threshold score, step 702, and the image remains unchanged for a time period that is larger than a threshold time, step 704, then an object is recognized, step 706.

After an object has been recognized, the EPE 404 checks whether the identified object is identical to a current object, step 708 if the identified object is not identical to the current object, then the current object is renamed as previous object, step 710, and the identified object is named as the current object, step 712. After naming the new current object, a new object event is created and its dependent conditions are achecked, step 714. The dependent conditions may affect which event action 306 (reaction chain) is selected and executed. After selecting an event action, step 716, the selected event action is executed, step 718, according to its priority.

Alternatively, the invention can be easily applied to security and education applications, where the UIUE and other elements are used to enhance security of a facility or to improve learning in a school setting. When used to enhance the security of a facility, the UIUE can monitor and interact with people entering the facility. A video camera will take a picture of a visitor, and the UIUE will check wether the visitor is a known person with information stored in its database. If the person is unknown, a speaker may interact with the person by asking information, then alerting a human for decision whether to allow the person to enter the facility. If the person is known, the UIUE may record time and date the person is entering the facility.

When the invention is used in an educational environmenet, the video camera may detect the presence of a pupil and carry on a conversation. The pupil may show an object to the camera, the UIUE will recognize it, a speaker may pronounce the object's name, and finally spell the object's name.

While the invention has been particularly shown and described with reference to a preferred embodiment thereof, it will be understood by those skilled in the art that various changes in form and detail maybe made without d parting from the spirit and scope of the present invention as set for the in the following claims. Furthermore, although elements of the invention may be described or claimed in the singular, the plural is contemplated unless limitation to the singular is explicitly stated.

1. An interactive device for receiving visual inputs from an environment and providing responses based upon the inputs, comprising:
an image sensor for capturing an external image of an object;
an image similarity engine for comparing the external image to a plurality of stored images, the image similarity engine providing a similarity score based on the comparison of the external image to a stored image; and
an event processing engine for creating a new event when the similarity score is bigger than or equal to a predefined threshold score, the event processing engine executing an event action associated with the new event.

2. The interactive device of claim 1, further comprising:
an audio sensor for capturing an audio command; and
a voice recognition engine for processing the audio command, the processed audio command being sent to the event processing engine.

3. The interactive device of claim 1, further comprising:
a database managing engine for receiving data requests from the event processing engine; and
a database for storing event data.

4. The interactive device of claim 1, further comprising:
a mechanical input processor for receiving mechanical inputs from the user;
a clock for providing timing functions to the event processing engine; and
a range finder for determining the distance between the video sensor and the object.

5. The interactive device of claim 1, further comprising:
a speech synthesizer; and
a speaker.

6. The interactive device of claim 1, wherein the event processing engine further comprising:
an event recognizer for creating a new event object for the new event and placing the new event object into an event queue;
an event queuer for managing the event queue;
an event conflict resolver for resolving conflicts between event objects placed in the event queue; and
an event handler for handling events in the event queue.

7. The interactive device of claim 1, wherein the event processing engine further comprising:
a category editor for creating new category for the new event;
an object editor for creating a new object for the new event;
a reaction editor for creating reactions for the new event; and
an event editor for defining new events.

8. The interactive device of claim 1, further comprising an event table, where the event table includes
a plurality of triggering conditions; and
at least one event action.

9. The interactive device of claim 1, wherein the image sensor is a video camera.

10. The interactive device of claim 1, wherein the image similarity engine further comprises a fractal based unconstrained image understanding processor.

11. The interactive device of claim 1, wherein the image similarity engine further comprises a non-fractal based unconstrained image understanding processor.

12. The interactive device of claim 1, wherein the device is embedded in a toy.

13. The interactive device of claim 1, wherein the device is embedded in security monitoring equipment.

14. The interactive device of claim 1, wherein the device is embedded in educational equipment.

15. A method for a device interacting with an environment, the device receiving visual inputs from the environment and providing an output according to the visual inputs received, comprising the steps of:
sensing an external image;
calculating a similarity score based on a comparison between the external image with at least one stored image;
if the similarity score is bigger than a predefined threshold score, generating a new event object; and
executing an event action associated with the new event object.

16. The method of claim 15, further comprising the steps of:
detecting a duration of the external image that is sensed by an image sensor; and
if the duration is bigger than a predefined time threshold, generating a new event object.

17. The method of claim 15, further comprising the steps of:
receiving environmental information; and
selecting an event action based on the environmental information.

18. The method of claim 17, further comprising the step of placing the event action into an event queue.

19. An interactive device that receives inputs from an environment and providing responses to a user, comprising:
an image sensing means for capturing an external image of an object;
an image similarity comparing means for comparing the external image to a plurality of stored images, the image similarity comparing means providing a similarity score based on the comparison of the external image to a stored image; and
an event processing means for creating a new event when the similarity score is bigger than a predefined threshold score, the event processing means executing an event action associated with the new event.
